(19) United States
(12) Patent Application Publication
(10) Pub. No.: US 2013/0052015 A1
(43) Pub. Date: Feb. 28, 2013

(54) ARRANGEMENT AND A METHOD IN CONNECTION WITH A FLOATING WIND TURBINE

(71) Applicant: Dag Velund, Sandnes (NO)

(72) Inventor: Dag Velund, Sandnes (NO)

(21) Appl. No.: 13/576,378

(22) PCT Filed: Feb. 1, 2011
(86) PCT No.: PCT/NO2011/000038

§ 371 Date: Nov. 14, 2012

(30) Foreign Application Priority Data
Feb. 1, 2010 (NO) 20100154

(51) Int. Cl. F03D 11/04

(52) U.S. Cl. 416/85; 405/195.1

(57) ABSTRACT

The present invention relates to a floating wind turbine (1), comprising a rotor (3), an upper column (5) connected to the rotor (3), and a stabilizer tank (4) disposed between the upper column (5) and a lower column (6), and an anchor (7) rotatably connected to the lower column (6), the stabilizer tank (4) having its centre of buoyancy eccentrically arranged in relation to a longitudinal centre axis through the upper (5) and the lower (6) column. The invention also relates to a method for the mounting and installation of a floating wind turbine (1).

The present invention relates to an arrangement and a method in connection with a floating wind turbine, and more specifically it relates to an arrangement and a method as disclosed in the preamble of claims 1 and 11, respectively.

There are already known offshore wind turbine concepts based on the use of onshore structures and tools, where in practice a bottom-fixed steel jacket is installed and an onshore turbine is subsequently mounted thereon. This works after a fashion, but involves major limitations such as limited water depth, weather exposure safety during installation involving high and heavy lifts, maintenance and costs. In addition, the aforementioned floating offshore turbines are anchored with the aid of a system comprising three anchor legs, each having a length of about three times the water depth, and thus take up large areas. As an example of the last-mentioned, one single wind turbine anchored in water at a depth of 330 metres will take up a circular seabed area of about 2000 metres in diameter, and a park consisting of such anchored wind turbines will therefore take up vast areas.

Today's area allocations for offshore wind turbines are showing greater depths and increasing distances from shore, and thus more demanding weather conditions and more difficult access. The need for installations, equipment and operations that meet the requirements these conditions result in is therefore assumed to be growing rapidly.

As an example of further prior art, mention can be made of a floating wind power plant with a stabiliser system of the tension leg type as described in NO 324756 B1.

A disadvantage of prior art wind turbines, both of the type for mounting on a bottom-fixed steel jacket and of the type described in NO 324756 B1 is that high cranes or the like must be used at the installation site, which is often far offshore where weather conditions are harsh. This entails a safety risk in harsh weather, or means that the installation time window is reduced to estimated safe weather periods.

The aforementioned and/or other disadvantages are, according to the invention, sought to be remedied or reduced by means of an arrangement and a method having the characteristic features disclosed in the characterising clause of claim 1 and claim 11, respectively.

Advantageous embodiments of the invention are set forth in the dependent claims.

In an aspect, the present invention relates to a wind turbine for the production of electric power mainly at intermediate and large ocean depths (40-300 m), where the turbine is manufactured and completed in sheltered waters (fjord/quayside), is towed out and installed on site, connected to a cable (network) and is ready for service/operation. The structure is based on a form of articulated tower with suitable buoyancy and stability, connected to a fixed seabed anchor via a universal joint. Owing to its design, the turbine itself assumes a correct angle in relation to the relevant wind direction. The concept is highly flexible, and can easily be adapted to the ocean depth and ground conditions at the installation site. The design provides substantial operating robustness in all phases.

The present invention is described in more detail below with reference to the attached drawings of non-limiting embodiments, wherein:

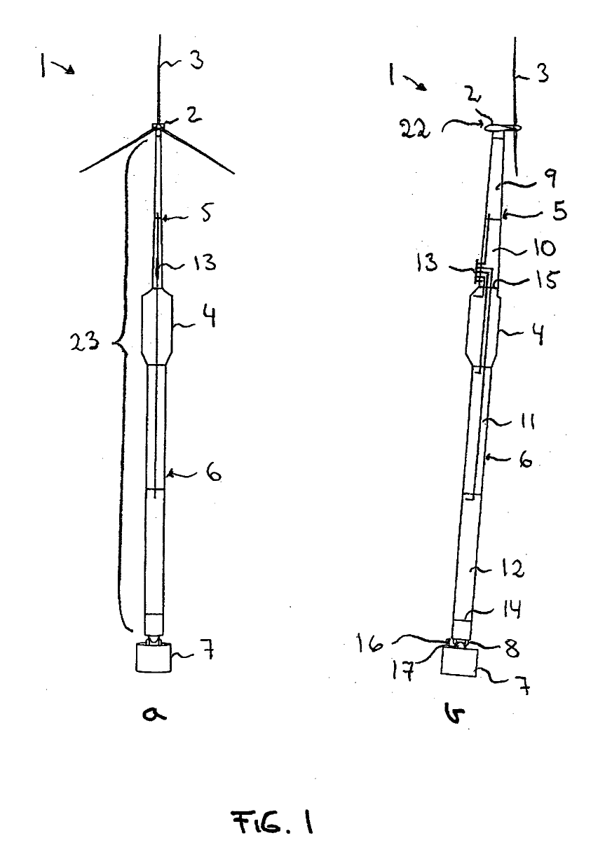

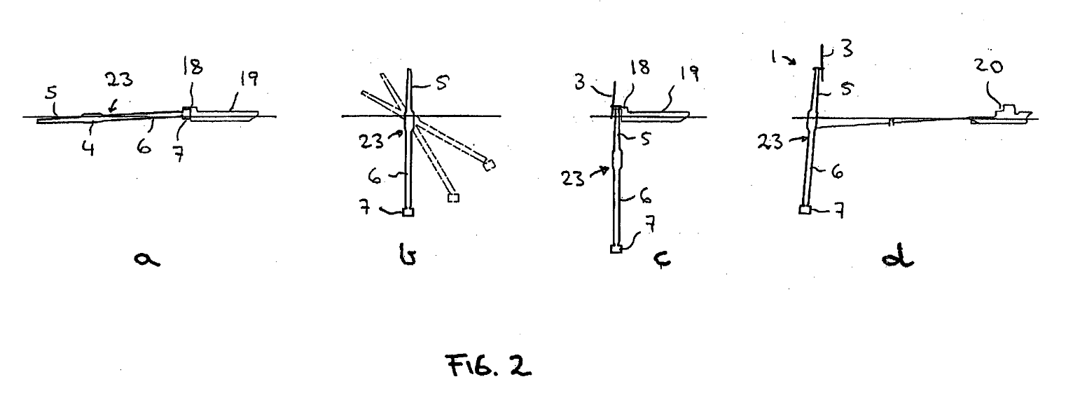

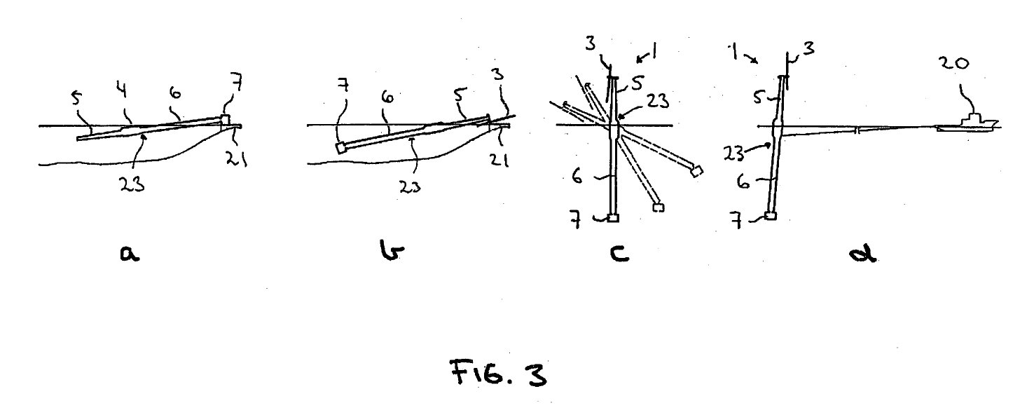

FIGS. 1 a and b show a wind turbine according to the invention, seen from the front and the side respectively, and with a ballast system for use during assembly and installation operations;

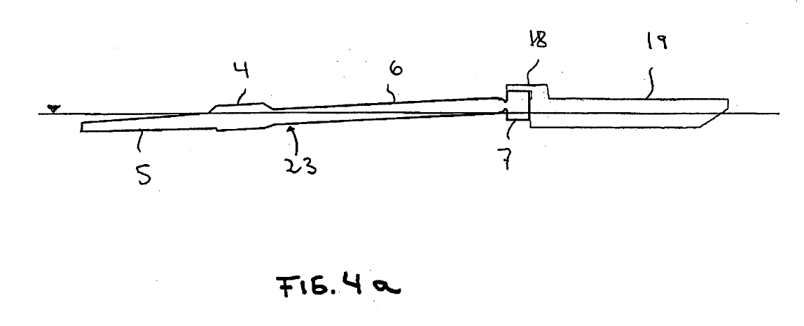

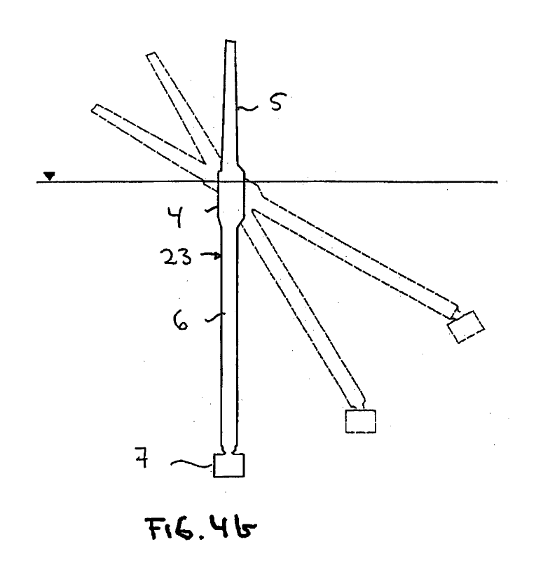

FIGS. 2 a-d show a basic overview of different phases or steps in a first embodiment of a method according to the invention;

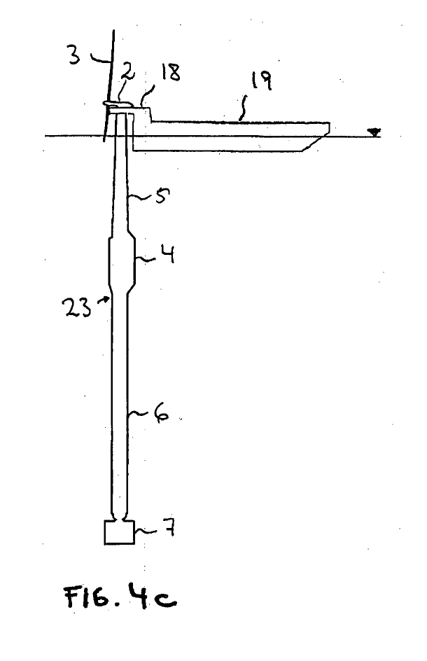

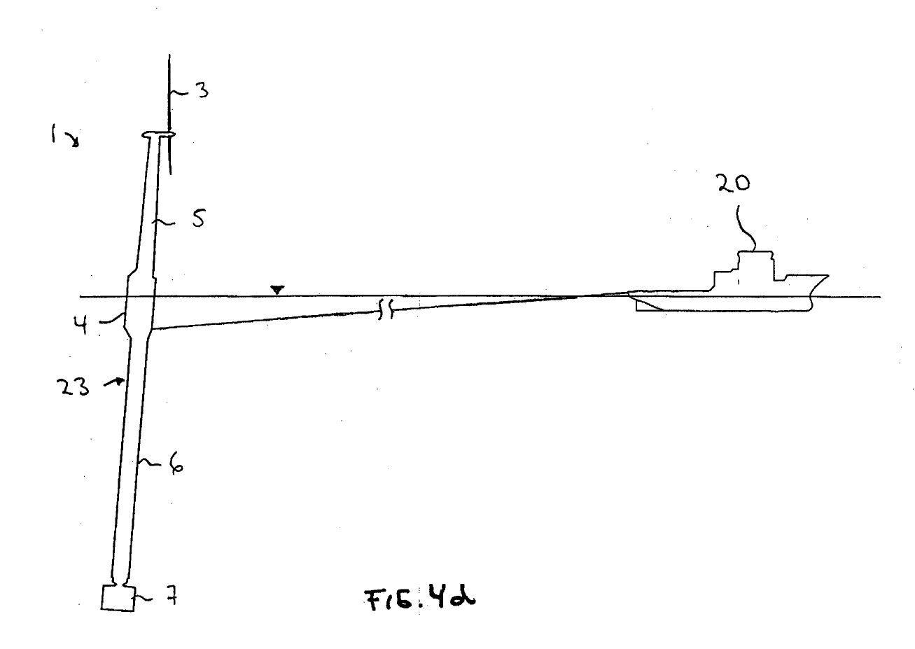

FIGS. 3 a-d show a basic overview of different phases or steps in a second embodiment of the method according to the invention;

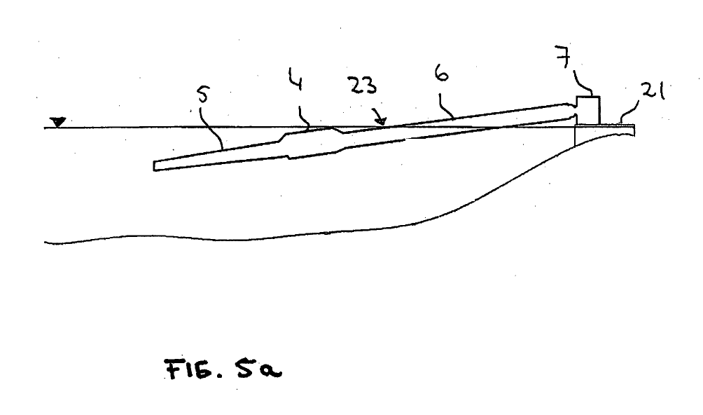

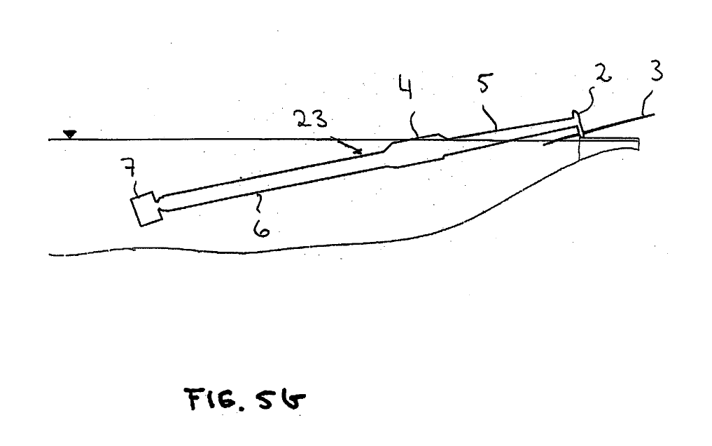

FIGS. 4 a-d show detailed views of the different phases or steps shown in, and which correspond respectively to, FIGS. 2 a-d; and

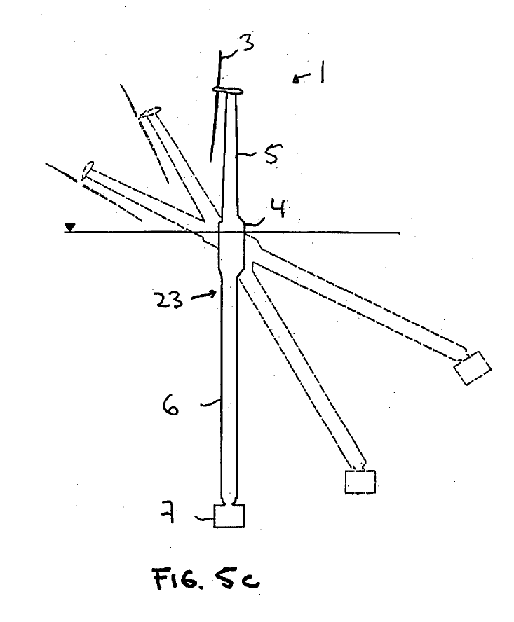

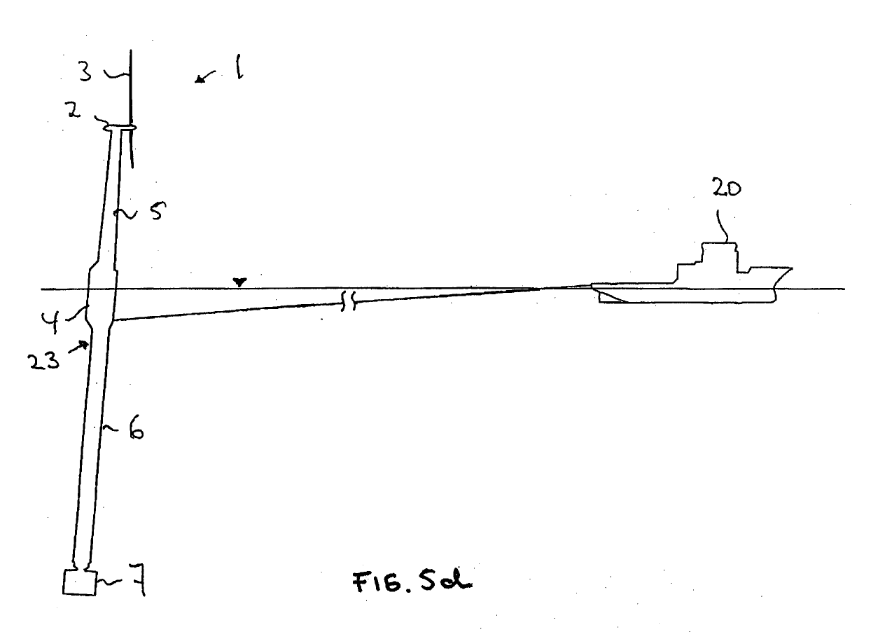

FIGS. 5 a-d show detailed views of the different phases or steps shown in, and which correspond respectively to, FIGS. 3 a-d.

Referring to FIG. 1, there is shown a wind turbine 1 of the downwind type according to an embodiment of the invention, comprising a nacelle 2, a rotor 3 attached to the nacelle 2, a stabilizer tank 4 disposed between an upper column 5 and a lower column 6 and a suction anchor 7 connected to the lower part of the column 6 via a universal or cardan joint 8 which permits rotation in all directions. As can also be seen from FIG. 1 a ballast system is advantageously provided, the upper and lower columns 5, 6 being divided into different chambers 9-12, which via respective lines run to a common outlet 13 for connection to an umbilical between a support vessel, not shown in the figure, and the wind turbine 1. As can be seen from the figure, the stabilizer tank 4 constitutes a separate chamber which is also connected to the common outlet 13 via a separate line.

The umbilical further contains advantageous systems for the supply of water/air and control systems for non-illustrated valves etc.

During operation, the stabilizer tank 4 is located below the water line, and, as can be seen from FIG. 1, the stabilizer tank 4 is advantageously eccentrically arranged in relation to a longitudinal centre axis of the upper 5 and the lower 6 column, the columns 5, 6 and the stabilizer tank 4 constituting the body 23 of the wind turbine 1. This eccentricity results in the centre of buoyancy of the tank 4 being moved up when the body 23 is bent in the wind direction, which thus limits the tilting and twisting of the body 23, in addition to the function the stabilizer tank 4 has during the handling of the wind turbine 1 in connection with transport and installation, as will be described in more detail below. The wind turbine 1 will, inter alia, float in a given rotational position about the centre axis, i.e., without rotating, when it is towed or manipulated whilst lying in the sea, and the stabilizer tank will serve as a centre of rotation when manipulating the wind turbine 1 from a horizontal to an upright position, or vice versa.

When a wind turbine 1 of the downwind type is used, the rotor 3 thus sits on the lee side of the upper column 5. The column 5 is advantageously given a permanent list in the wind direction of 5° when the rotor 3 is vertical, increasing to 6-7° with increasing wind speed and resultant increased wind pressure against the rotor 3 and the column 5. A downwind rotor 3 will have its centre of force some distance (typically a few metres) in the wind direction from the rotational centre of the column 5 at a lower anchoring point. A slewing ring 14 in this lower area, together with a slip ring 15 arranged in a cross-section of the column 5 immediately above the water line, permits column 5 and rotor 3 to operate with the wind. The rotor 3 is thus directed or projected at right angles to the wind direction without any need for a supply of additional mechanical force. The slewing ring 14 may advantageously have specifications like those for slewing rings used, for example, in Liebherr construction cranes, as these can withstand water/salt and long-term extreme use.

The slewing ring 14 and the slip ring 15 will advantageously have a design that prevents any twisting of an electrical cable that runs downwards in the wind turbine 1 from a generator arranged in the nacelle 2 to the distribution network via a lower part of the wind turbine 1.

Furthermore, as can be seen from FIG. 1, the upper column 5 advantageously has a drop- or wing-shaped cross-section, where the tip or the pointed end of the drop points at all times in the wind direction to ensure a maximally laminar air stream behind the column 5 so that the rotor mechanism is loaded to a lesser extent than if each of the rotor's 3 three blades were to meet a turbulent area each time they pass behind the column 5. Related to other parts of the wind turbine 1, the tip of the wing or drop is thus advantageously arranged along the same horizontal axis as the horizontal shaft of the wind turbine 1 and pointing in the direction of the rotor 3.

Similarly, as also can be seen from FIG. 1, the nacelle 2, too, is advantageously provided with a wing shape to ensure a maximally homogenous air stream against the rotor 3, although the negative effect of an inhomogeneous air stream is smallest closest to the centre of the rotor 3. The wing shape of the nacelle 2 will create lift/drag which counteracts bending of the column 5 in the wind direction in strong wind conditions, thereby contributing to increased rigidity of the wind turbine 1 as a whole.

Unlike the upper column 5, the lower column 6 advantageously has a cylindrical cross-section and, in addition to variable water ballast, has a certain amount (not shown) of fixed ballast, for example, in the form of olivine. The same column 6 is provided with buoyancy in an upper portion below the water line, as increased buoyancy in an upper portion of the column 6 together with the fixed ballast in the lower part of the column will give a hydrodynamically stable (rigid) column 6.

As indicated above, the volume of the stabilizer tank 4 is adapted to the need for “rigidity” in the structure, where a heavy duty generator calls for greater “body rigidity” (larger volume of the tank) than a smaller generator. The eccentric arrangement of the stabilizer tank, with more volume on the windward side of the body 23, results in reduced twisting of the body 23, as mentioned above, and ensures maximum projection of the rotor 3 towards the wind on increasing wind pressure. The column 6 and the stabilizer tank 4 will advantageously have a total length (depth) which essentially corresponds to the water depth at the installation site.

The drawings show a wind turbine 1 of the horizontal shaft type with the generator placed in the nacelle 2. In an alternative, non-illustrated embodiment, the generator is arranged vertically inside the column 5 and connected to the rotor 3 via an angular gear in the nacelle 2. As an alternative to being of the horizontal shaft type, the wind turbine 1 may be of the vertical shaft type, and in that case both the upper and lower columns 5, 6 advantageously have a cylindrical cross-section. In the last-mentioned alternative, there will be no need for a slewing ring 14 and slip ring 15, which means a simplification and thus a reduction in costs. In this alternative, the body 23 will advantageously have a vertical position in the water, but will inevitably be tilted slightly by wind and wave forces. Similarly, the height of the upper column 5 could be reduced slightly in a wind turbine of the vertical shaft type, as the need for distance between rotor blades and sea will not be a relevant issue.

Referring to FIGS. 2-5, there are shown two embodiments of the method according to the invention. A first embodiment of the method, here also called “the deep water method” is shown in principle in FIG. 2, whilst a second embodiment of the method, also referred to here as “the workyard method” is shown in principle in FIG. 3.

A brief description of an advantageous embodiment of “the deep water method” is as follows: The body 23 is towed to a deep fjord, whereupon the body 23 is ballasted to a desired draught so that a lower end 16 of the column 6 has the same elevation as a connecting joint 17 on the suction anchor 7 which now hangs from a stand 18 at the aft end of a barge 19, the connecting joint 17 now being immediately above the water surface. The anchor 7 and column 6 are connected to each other, released from the barge 19, ballasted to a vertical position and lowered to 6-7 m freeboard, and manoeuvred below the nacelle 2 which is now placed on the stand 18 on the same barge 19. The body 23 is then deballasted until it comes into contact with the nacelle 2, mounted together with the last-mentioned and further deballasted to towing depth. After internal preparation, the now complete wind turbine 1 is towed to the location for anchoring and installation.

FIGS. 2 a-d show the four phases of an embodiment of the deep water method in more detail.

A first phase, shown in FIG. 2a, advantageously comprises the following steps:
the barge 19 fetches the anchor 7 from the workyard;
the anchor 7 is suspended from/secured on the stand 18;
the barge 19 with anchor 7 is towed to the construction site;
the anchor is connected dry to the body 23;
the body 23 is made ready for positioning upright (upending).

A second phase, shown in FIG. 2b, advantageously comprises the following steps:
a ballasting hose (not shown) is connected to the common outlet 13; the body 23 is ballasted to 5° tilt and 5 m freeboard;
the column is positioned below the stand 18 on the aft end of the barge 19;
a complete nacelle 2 is lifted into the stand 18.

A third phase, shown in FIG. 2c, advantageously comprises the following steps:
the body 23 is deballasted;
the weight of the nacelle 2 is gradually transferred from the stand 18 to the body 23;
the complete nacelle 2 is mounted to the body 23;
the body 23 is deballasted to “mounting freeboard”;
fixed ballast is transferred to the body 23;
testing and preparation for towing.

A fourth phase, shown in FIG. 2d, advantageously comprises the following steps:
ballasting to towing draught;
connection to the tow boat 20;
towing out;
positioning;
anchoring and installation;
connection to the distribution network.
testing and start-up.

A brief description of an advantageous embodiment of “the workyard method” is as follows: The anchor 7 is placed on the edge of a quay 21 (or under a stand on the front edge of a quay). The body 23 is towed from its mooring point and is positioned with its lower end 16 towards the anchor 7. The body 23 is then ballasted at its upper part 5 until the lower end 16 has the same elevation as the connecting joint 17 on the anchor 7. The anchor 7 and the body 23 are then connected to each other. The body 23 is then deballasted at its lower part 6 and ballasted at the upper part 5. With the body 23 as an arm, the anchor 7 is then lifted from the quay 21, whereupon the body 23 is moved out from the quay 21, and then manoeuvred with an upper end 22 towards the quay 21 on which the complete nacelle 2 is placed at a correct angle in its stand 18, with the end 16 facing the sea. Then body 23 is ballasted to the correct level and mounted together with the nacelle 2. The body 23 is subsequently deballasted at the upper end 22 connected to the nacelle 2, which results in the nacelle 2 being lifted free of its stand 18 on the edge of the quay 21. The wind turbine 1 is towed in horizontal position from the quay 21 to deep water and upended, whereafter the same procedure as for the deep water method is followed for anchoring and installation.

FIGS. 3 a-d show the four phases of an embodiment of the workyard method in more detail.

A first phase, shown in FIG. 3a, advantageously comprises the following steps:
the body 23 is launched from the workyard:
the anchor 7 on the quay 21, turned 90°;
the joint 17 is mounted and made ready;
the body 23 is ballasted at the upper part 5;
elevation at the lower end 16 is adjusted to the centre of the joint 17;
the body 23 is positioned towards the joint 17;
the body 23 and the anchor 7 are connected at the joint 17;
the body 23 is ballasted and moved out from the quay 21.

A second phase, shown in FIG. 3b, advantageously comprises the following steps:
the upper end 22 of the body 23 is moved towards the quay 21;
the body 23 is connected to the prepared nacelle 2 on the quay 21;
the body 23 is ballasted;
a complete wind turbine 1 is towed to a deep water area.

A third phase, shown in FIG. 3c, advantageously comprises the following steps:
the wind turbine 1 is anchored and ballasted in the part 6 of the body 23;
the wind turbine 1 is towed to a deep water site and anchored;
the wind turbine 1 is ballasted into the vertical position;
fixed ballast is transferred to the column;
testing and preparation for towing.

A fourth phase, shown in FIG. 3d, advantageously comprises the following steps:
the wind turbine 1 is ballasted to towing draught;
tow boat 20 is connected to the wind turbine 1;
the wind turbine is towed out and positioned at its mounting location;
anchoring and installation;
connection to the distribution network.
testing and start-up.

The aforementioned methods according to the invention thus make possible the mounting of the wind turbine 1 in a weather-safe location far from the installation site, and where the mounting and installation operations can take place in a safe and cost-efficient manner from a point immediately above the water surface without using huge cranes or the like.

In the above description and in the claims the term “floating” wind turbine is used as the wind turbine is handled and towed whilst floating to the installation site for anchoring, and when anchored is kept in a floating position by means of its own buoyancy. However, this term does not preclude that the wind turbine or parts thereof may be stored ashore or on a vessel, for example, during production, installation or repair/upgrading. An alternative term for the wind turbine in floating and anchored position on location/installation site may thus be “dynamically anchored”, as the wind turbine is allowed to move dynamically in relation to the wind and current conditions prevailing at any given time.

Although a suction anchor has been shown and described in the above embodiments, other anchor types are also conceivable within the scope of the invention. Similarly, other alterations and modifications are possible within the scope of the invention as disclosed in the attached claims.

1. A floating wind turbine, comprising:
a rotor,
an upper column connected to the rotor, and
a stabilizer tank disposed between the upper column and a lower column, and
an anchor rotatably connected to the lower column,
wherein the upper and lower columns and the stabilizer tank comprise the body of the wind turbine,
wherein a number of chambers are provided in the upper column and the lower column, wherein the number of chambers, together with the stabilizer tank, are included in a ballast system for the wind turbine,
wherein the ballast system is configured to allow floating manipulation of the body's position in the water for connection of the rotor and the anchor to respective ends of the body from a vessel or from a quay from a position immediately above the water surface, in use.

2. A wind turbine according to claim 1, wherein the stabilizer tank has its centre of buoyancy eccentrically arranged in relation to a longitudinal centre axis through the upper and the lower column.

3. A wind turbine according to claim 1, wherein the wind turbine is of the horizontal shaft type and of the downwind type and further comprises a nacelle connected to the rotor and the upper column.

4. A wind turbine according to claim 1, wherein the wind turbine is of the vertical shaft type.

5. A wind turbine according to claim 1, wherein the upper column has a wing-shaped or drop-shaped cross-section, wherein the tip of the wing or the drop is arranged along the same horizontal axis as the horizontal shaft of the wind turbine and pointing in the direction of the rotor, and wherein the lower column has a circular cross-section.

6. A wind turbine according to claim 4, wherein the upper and the lower column have a circular cross-section.

7. A wind turbine according to claim 1, wherein the nacelle has a wing shape configured to create lift for the nacelle.

8. A wind turbine according to claim 1, further comprising a lower slewing ring and an upper slip ring arranged in the body.

9. A wind turbine according to claim 1, wherein an anchor is attached to a lower end of the column, via a cardan joint.

10. A wind turbine according to claim 9, wherein the anchor is a suction anchor.

11. A method for the mounting and installation of a floating wind turbine as disclosed in claim 1, the method comprising the steps of:
floatingly manipulating the position of the body in the water, and
connecting the rotor and the anchor at respective ends of the body from a vessel or from a quay, from a position immediately above the water surface.

12. A method according to claim 11, further comprising:
arranging the body lying floating essentially horizontally in the sea by a quay;
ballasting the body so that a lower part of the body is lifted from the sea;
positioning the lower part towards an anchor lying on the quay;
connecting the anchor to the lower part of the body;
ballasting the body connected to the anchor further so that the anchor is lifted from the quay;
turning the body connected to the anchor in the sea so that an upper part of the body faces towards the quay;
positioning the upper part of the body towards a rotor-comprising part lying on the quay;
connecting the rotor-comprising part to the upper part of the body;
ballasting the body further such that the rotor-comprising part is lifted from the quay; and
towing the thus mounted wind turbine from the quay.

13. A method according to claim 12, comprising the additional steps of:
towing the turbine to a sea area deep enough to allow vertical positioning of the wind turbine;
ballasting the turbine into the vertical position;
towing the vertically positioned turbine to the installation site;
anchoring and installing the wind turbine at the installation site.

14. A method according to claim 11, further comprising:
towing the body to a sufficiently deep mounting site offshore;
ballasting the body such that a lower end of the body has the same elevation as an anchor arranged on a vessel;
connecting the lower end to the anchor;
releasing the anchor from the vessel;
positioning the body with the anchor in a vertical position;
ballasting the vertically positioned body with the anchor at the right depth for connection to a rotor-comprising part lying on the vessel;
positioning and connecting the upper end of the body to the rotor-comprising part, so that a complete wind turbine is obtained, releasing the complete, vertically positioned wind turbine from the vessel;
towing the vertically positioned turbine to the installation site; and
anchoring and installing the wind turbine at the installation site.

15. A method according to claim 11, wherein the rotor-comprising part is a nacelle with a rotor of the horizontal shaft type.

16. A method according to claim 11, wherein the rotor-comprising part is a rotor of the vertical shaft type.

17. A method according to claim 11, wherein the anchor is a suction anchor.

18. A method according to claim 11, wherein the vessel is a barge on the aft end of which there is arranged a stand.
